(19) United States
(12) Patent Application Publication
(10) Pub. No.: US 2026/0261853 A1
(43) Pub. Date: Sep. 3, 2026

(54) DYNAMIC ADDITION OF MOBILE CONSTRAINED MEC HOST

(71) Applicant: InterDigital Patent Holdings, Inc., Wilmington, DE (US)

(72) Inventors: Debashish Purkayastha, Eagleville, PA (US); Robert Gazda, Spring City, PA (US); Kevin Di Lallo, Laval (CA)

(73) Assignee: InterDigital Patent Holdings, Inc., Wilmington, DE (US)

(21) Appl. No.: 19/163,456

(22) PCT Filed: Apr. 11, 2024
(86) PCT No.: PCT/US2024/023964

§ 371 Date: Sep. 9, 2025

Related U.S. Application Data
(60) Provisional application No. 63/459,051, filed on Apr. 13, 2023.

(51) Int. Cl. H04W 12/06; H04L 41/0895; H04W 8/22

(52) U.S. Cl. CPC H04W 12/06; H04L 41/0895; H04W 8/22

(57) ABSTRACT

A wireless transmit/receive unit (WTRU) may send a request associated with multi-access edge computing (MEC) host integration. The request may comprise security credentials and/or an indication that the WTRU intends to join a MEC system. The WTRU may receive a response. The response may indicate host integration options supported by the MEC system. The WTRU may select one or more host integration options indicated in the response based on one or more capabilities associated with the WTRU. The WTRU may send a notification to the MEC system. The notification may indicate the one or more selected host integration options. The WTRU may be a constrained MEC host. The request, response, and/or notification may be sent/received to/from an Operations Support System (OSS). The request, response, and/or notification may also be sent/received to/from a MEC orchestrator (MEO).

### CROSS REFERENCE TO RELATED APPLICATIONS

This application claims the benefit of U.S. Provisional Patent Application No. 63/459,051, filed on Apr. 13, 2023, the entire contents of which are incorporated herein by reference.

### BACKGROUND

The MEC (e.g., Mobile Edge computing) may include capabilities deployed in the edge of the mobile network that can facilitate the efficient and/or dynamic provision of services to mobile users. An open environment for integrating MEC capabilities with service providers' networks may include applications from third parties. These distributed computing capabilities may make available IT infrastructure as in a cloud environment for the deployment of functions in mobile access networks.

### SUMMARY

Systems, methods, and apparatuses as described herein may enable an authorized user, administrator, wireless transmit receive unit (WTRU) and/or a constrained device to inform a multi-access edge computing (MEC) system (e.g., via an Operations Support System (OSS)) about a Constrained MEC host (CMH). The authorized user, administrator, WTRU and/or constrained device may configure a MEC orchestrator (MEO) with Constrained MEC host information.

Systems, methods, and apparatuses are described herein with respect to MEO Initiated Constrained Host addition. The MEO may be notified (e.g., through a network exposure function (NEF), Location service) about a mobile Constrained MEC host availability in a desired location and/or service area. The MEO may initiate contacting the Constrained MEC Host through the device's Management URL to authenticate and/or authorize the constrained MEC host, verify trust credential(s), and/or check hardware and/or software integrity. The MEO may request for Constrained MEC Host capability and/or supported MEC management interface(s). The MEO may receive the MEC management interface information and/or may use the MEC management interface information to manage, configure, and/or orchestrate the Constrained MEC Host.

Systems, methods, and apparatuses are described herein with respect to Constrained MEC host initiated addition. A mobile Constrained MEC Host may request an MEO to join the MEC system by sending Security credential(s), Trust credential(s), and/or Host capability information including available MEC management interfaces. The Constrained MEC host may receive a response from the MEO indicating if its request is accepted or rejected along with integration option(s) supported by the MEO. The Constrained MEC Host may select the MEO suggested integration option(s) and/or may inform the MEO. The Constrained MEC Host may receive management, configuration, and/or orchestration information from the MEO on the selected management interfaces.

Systems, methods, and apparatuses are described herein with respect to dynamic addition of mobile constrained MEC host. A network node may receive a request from a WTRU, wherein the request includes first information associated with the WTRU and a constrained MEC host. The network node may verify the WTRU using the first information. The network node may send the first information about the constrained device or WTRU to an MEO.

A WTRU may send a request associated with multi-access edge computing (MEC) host integration. The request may comprise security credentials and/or an indication that the WTRU intends to join a MEC system. The security credentials may include one or more of software details, a hash of a software image, trust parameters, and/or certificates to be used by an MEO to validate the request. In some cases, the request may also indicate host integration options supported by the WTRU.

The WTRU may receive a response. The response may indicate host integration options supported by the MEC system. The WTRU may also determine whether any of the host integration options are indicated as mandatory. The host integration options may comprise support of integration over Mm3 and Mm4, support of integration over Mm5 and Mm7, multi access edge platform (MEP) and virtualization infrastructure, and/or multi access edge platform manager (MEPM) and virtualization infrastructure manager. The WTRU may select one or more host integration options indicated in the response based on one or more capabilities associated with the WTRU. The one or more capabilities associated with the WTRU may comprise the WTRU supporting one or more selected host integration options.

The WTRU may send a notification to the MEC system. The notification may indicate the one or more selected host integration options. The WTRU may be a constrained MEC host. The request, response, and/or notification may be sent/received to/from an Operations Support System (OSS). The request, response, and/or notification may also be sent/received to/from a Multi access edge orchestrator (MEO).

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a system diagram illustrating examples of Multi-access Edge Computing (MEC) concepts.

FIG. 3 is a system diagram illustrating an example MEC reference architecture.

FIG. 4 is a system diagram illustrating an example CMEC host.

FIG. 5 is a flow diagram illustrating an example of configuring of a MEC orchestrator (MEO) by an authorized user.

FIG. 6 is a flow diagram illustrating an example of multiaccess edge orchestrator (MEO) initiated addition of a mobile constrained MEC host (CMH).

FIG. 7 is a flow diagram illustrating an example of CMH initiated addition and/or joining a MEC system.

### DETAILED DESCRIPTION

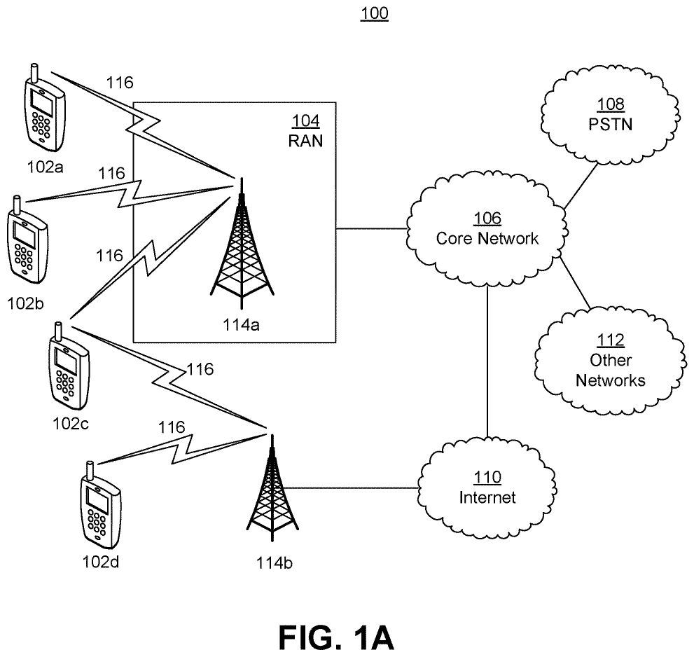

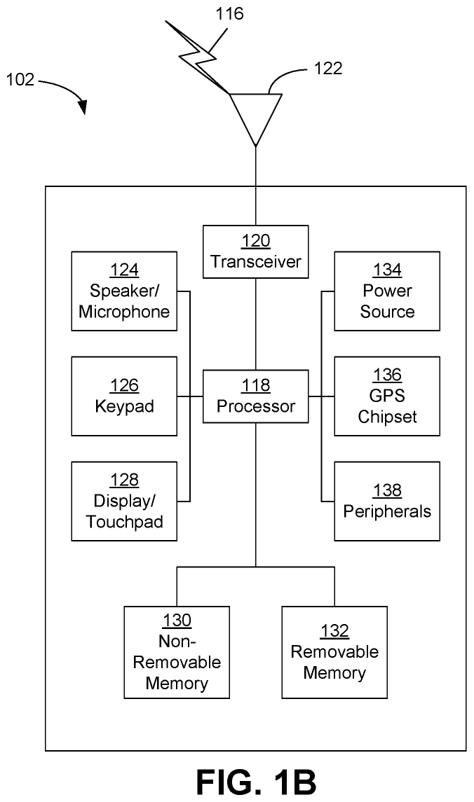

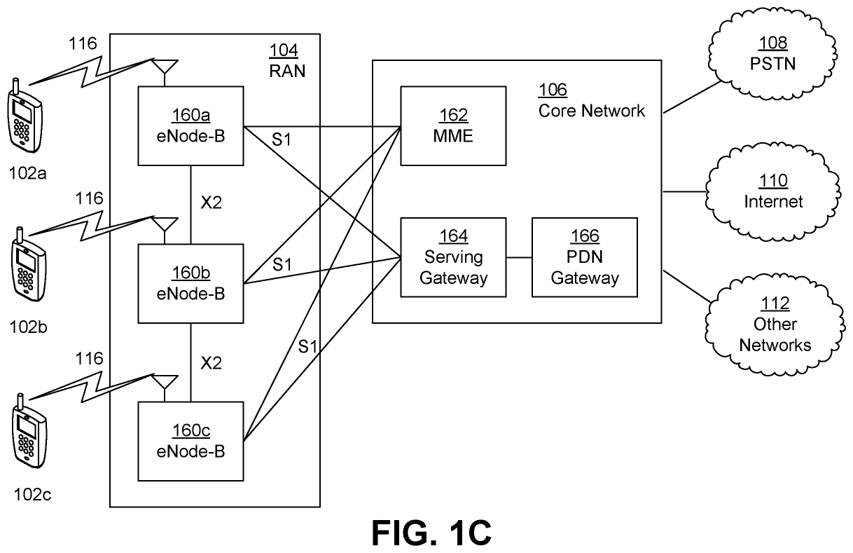

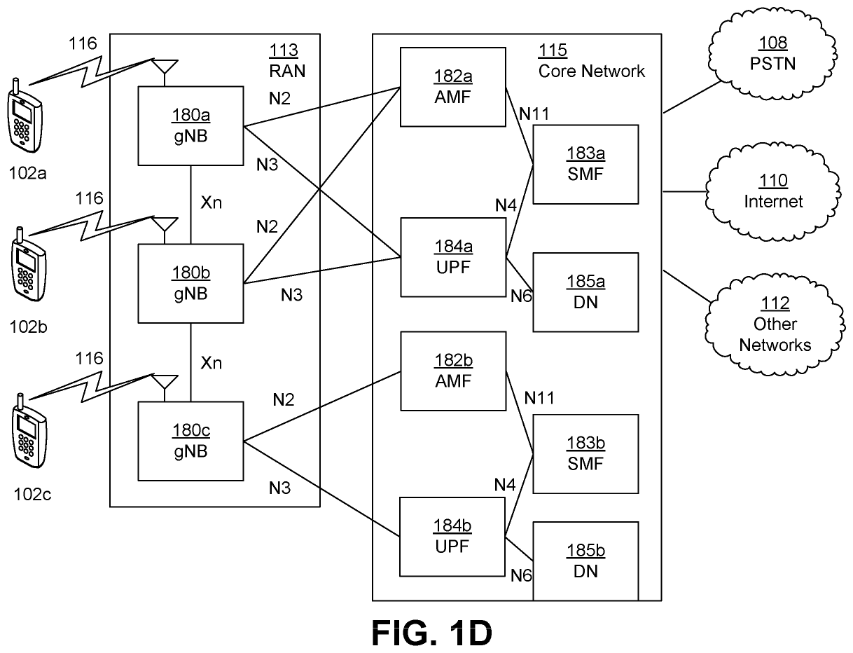

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122.

More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102.

For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

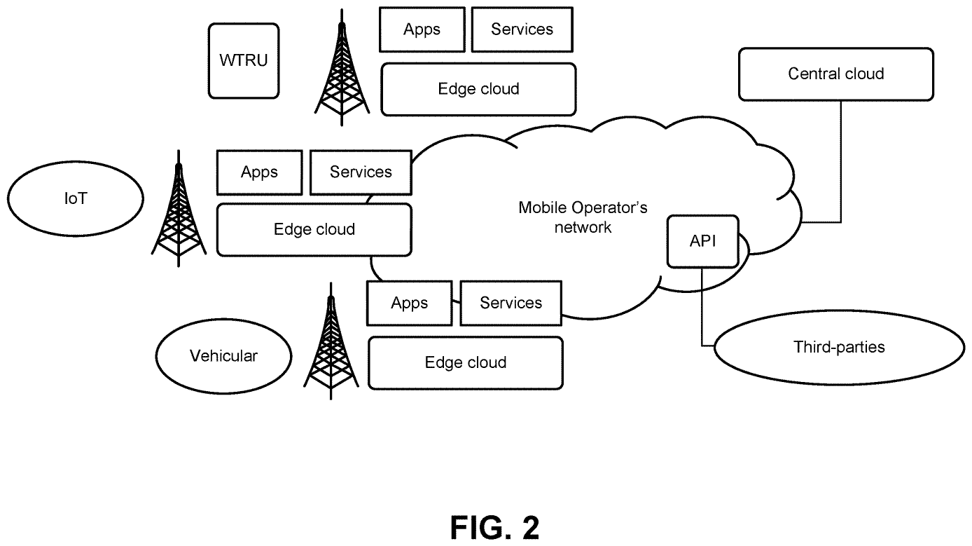

FIG. 2 illustrates examples of Multi-access Edge Computing (MEC) concepts. The MEC (e.g., formerly known as Mobile Edge computing) may include capabilities deployed in the edge of the mobile network that can facilitate the efficient and/or dynamic provision of services to mobile users. An open environment for integrating MEC capabilities with service providers' networks may include applications from third parties (e.g., as shown in FIG. 2). These distributed computing capabilities may make available IT infrastructure as in a cloud environment for the deployment of functions in mobile access networks.

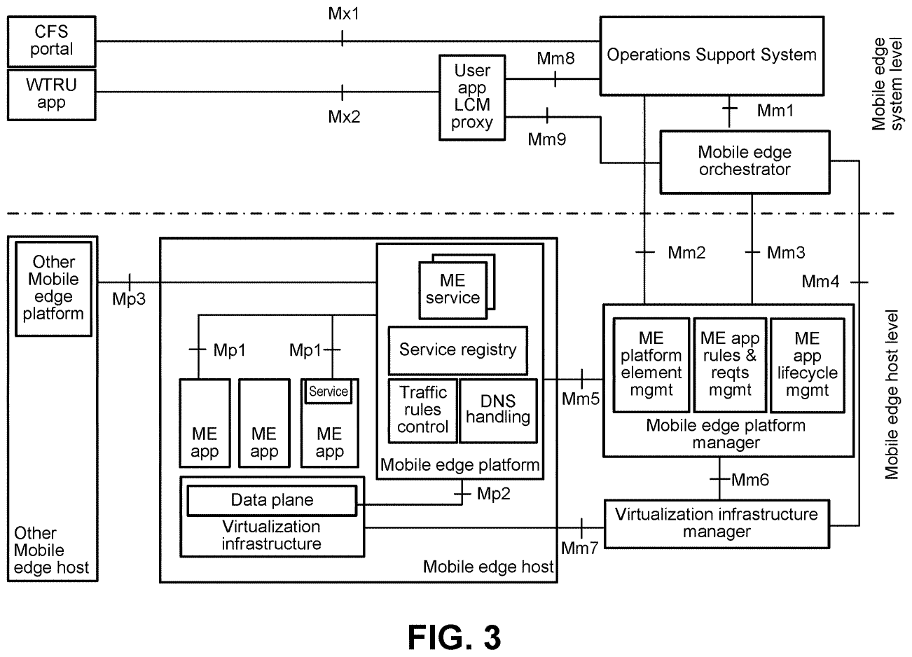

FIG. 3 illustrates an example MEC reference architecture with functional elements that include the mobile edge system and/or the reference points. The MEC reference architecture may include one or more (e.g., three) groups of reference points between the system entities: Reference points regarding the mobile edge platform functionality (Mp); Management reference points (Mm); and/or reference points connecting to external entities (Mx).

The mobile edge system may include the multi access edge hosts and/or the multi access edge management to run mobile edge applications within an operator network and/or a subset of an operator network.

The multi access edge host may be an entity that includes a multi access edge platform and/or a virtualization infrastructure which provides computing, storage, and/or network resources, for example, for the purpose of running multi access edge applications. The multi access edge host may be deployed in Mobile Network Operator (MNO) and/or edge service provider data center(s) in fixed location(s). Multi access edge hosts may not be (e.g., dynamically) added to a MEC system via standardized method(s).

The multi access edge platform (MEP) may include the collection of essential functionalities to run mobile edge applications on a particular virtualization infrastructure and/or enable them to provide and/or consume mobile edge services.

Multi access edge applications (MEC Apps) may be instantiated on the virtualization infrastructure of the mobile edge host based on configuration requests validated by the mobile edge management.

The mobile edge management may include the mobile edge system level management and/or the mobile edge host level management.

The mobile edge system level management may include the multi access edge orchestrator (MEO) as its core component. The MEO may have an overview of the (e.g., complete) mobile edge system.

The mobile edge host level management may include the multi access edge platform manager (MEPM) and/or the virtualization infrastructure manager (VIM), and/or may handle the management of the mobile edge specific functionality of a particular mobile edge host and/or the application(s) running on it.

Terminal units, mobile hosts, and/or personal devices may be used to support cloud computing at the edge.

Support for MEC may be included in a Constrained device. Terminal units, mobile hosts, and/or personal devices may be used to support cloud computing at the edge. In examples, limited computing resources may be available for running MEC applications and/or its impact on life cycle management of VMs, Containers, and/or other form of virtual instances. In examples, mobility of constrained terminals may impact reachability of MEC applications, maintenance of reasonable connectivity, device availability, and/or discoverability of appropriate services. In examples, MEC may impact unavailability of reliable high bandwidth backhaul connectivity (e.g., wired or wireless). In examples, when the constrained MEC host is mobile, it may be impacted by unavailability of reliable high bandwidth (BW) backhaul connectivity.

The MEC host may be mobile. The MEC host may not have high BW connectivity and/or backhaul. Since the MEC host may be mobile, the MEC host may go out of reach for an application service, whereas a different MEC host may become available. In order to integrate the mobile MEC host(s), the MEC system may verify security, trust, etc. Security and/or authorization may be required to use a constrained terminal and/or privacy of user data. For example, MEC may be applied to support cloud computing on such constrained environments.

There may be scenarios where it is advantageous to enable a reduced capability MEC platform (e.g., Constrained MEC, CMEC) for deployment on constrained devices, for example, to allow MEC apps to be installed on the one or more constrained devices.

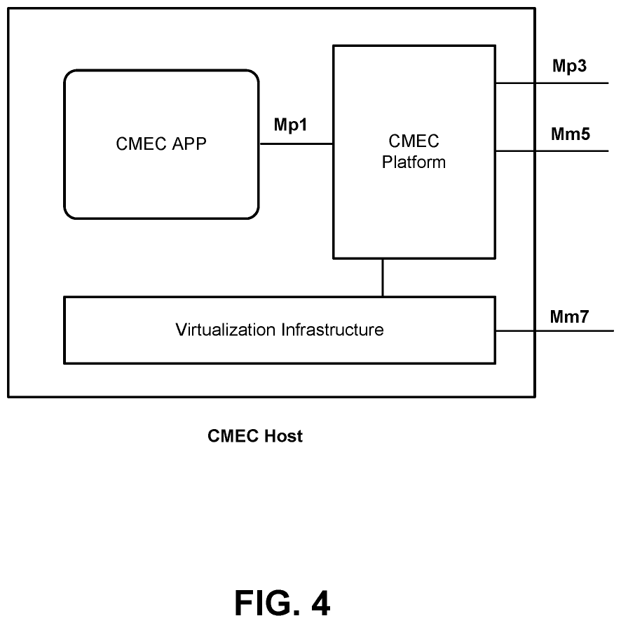

FIG. 4 depicts an example CMEC Host. The CMEC Host or Constrained MEC Host (CMH) may be an ETSI MECH Host with a MEC platform (e.g., CMEC Platform) supporting one or more reduced functions and/or features (e.g., compared to a full featured Telco or Infrastructure MEC Platform. The CMEC Apps, for example may use Mp1 interface to interact with the CMEC Platform.

Additionally, or alternatively, the CMEC may be referred to as a Host, CMH without one or more (e.g., any) MEC Platform. The CMH may have a virtualization infrastructure capable of deploying and/or running MEC application(s).

The CMH may support one or more (e.g., all) MEC interfaces such as Mp1 (e.g., full standardized interface), Mp3, Mm5, Mm7, and/or a subset of the interfaces described herein. For Constrained MEC Host, an implementer may implement a reduced set of functions for these interface. The implementer may not offer one or more (e.g., all) MEC services, e.g. RNIS may be offered while BWM may not be offered. It may have restriction on the number of services that may be running at a certain instant of time. It may have restriction(s) on the number of requests it can handle and/or try to save power by going into sleep mode.

There may be different use cases that would benefit from such a deployment scenario, including but not limited to the following. In examples, a use case may include vehicular scenario(s), where a CMH embedded in a vehicle runs application(s) for one or more other neighboring vehicles (e.g., in platooning situations) and/or for the edge network (e.g., for safety and traffic efficiency applications). In examples, a use case may include one or more industry (e.g., industry 4.0) scenarios, where mobile robots, robot arms, and/or mobile cameras can also host MEC applications to minimize the latency required by certain use cases. In examples, a use case may include home gaming scenarios, where cloud-based gaming applications using augmented reality (AR) and/or virtual reality (VR) may include ultra-low latencies and/or extended computational capabilities (e.g., which can be provided by CMECs in the same household). The use cases herein may include constrained MEC hosts which are mobile (e.g., CMG in vehicle, Robots with CMH, etc.)

In the industry 4.0 scenario, for example, there may be one or more (e.g., numerous) cameras and/or sensors on the factory floor. One or more (e.g., some) cameras may be mobile (e.g., on-wheels) (e.g., carried by guided vehicles). One or more mobile cameras and/or sensors may monitor (e.g., continuously monitor) production lines in the factory. The one or more mobile cameras and/or sensors may include a CMH. The CMH may provide Far Edge service for one production line while another set of sensors may provide Far Edge service for another production line. The mobile camera(s) and equipment may run Federated learning applications on the CMH.

As these mobile CMHs move around, one or more CMH may periodically be out of coverage, due to coverage and proximity, for example. In examples, a MEC application (e.g., Federated Learning Agent) hosted in a first CMH, CMH1, may be out of reach for a service, while another CMH, CMH2, may become available. Mobile CMH2 may be added to the far edge service by MEO, for example, based on the location of CMH2. CMH2 may be added to the far edge service by MEO based on one or more capabilities such as a camera, a robot version, a manufacturer, etc.

The deployment scenarios described herein may benefit if the constrained MEC Hosts, which are mobile, offer services dynamically, by becoming part of the larger computing infrastructure (e.g., Telco Edge and Device Edge combined).

When a CMH (e.g., a mobile CMH) becomes part of the MEC system, the CMH may interoperate and/or share compute resource(s) with Telco Edge cloud services. In examples, a CMH may be supplied by a third party, purchased by a vehicle manufacturer, and/or installed as an in-vehicle MEC. The constrained MEC host may become mobile and/or may become part of the MNO's edge computing infrastructure to provide autonomous vehicle services. The integration (e.g., dynamic integration) of CMEC Hosts with MEC system, for example, may be managed and/or controlled by MNO and/or third-party service provider.

For a mobile CMH, to operate as part of the MEC system (e.g., Telco edge and Device Edge), the mobile CMH may be dynamically added to the MEC system by a user, cloud service provider, application service provider, and/or third party service provider.

An authorized user, administrator, wireless transmit receive unit (WTRU), and/or a constrained device may inform a multi access edge computing (MEC) system (e.g., via an operations support system (OSS)) about a (e.g., new) Constrained MEC host (CMH). The authorized user, administrator, WTRU, and/or constrained device may configure the MEC orchestrator (MEO) with Constrained MEC host information. The constrained MEC host information may include one or more of security credentials, management interface information for initial contact, etc.

Systems, methods, and apparatuses are described herein with respect to MEO Initiated Constrained Host addition. The MEO may be notified (e.g., through network exposure function (NEF), Location service) about a Constrained MEC host availability in a desired location and/or service area. The MEO may initiate contacting the Constrained MEC Host through the device's Management URL, for example, to authenticate and/or authorize the constrained MEC host, verify trust credential(s), check hardware integrity, and/or check software integrity. The MEO may request Constrained MEC Host capability and/or supported MEC management interface(s). The MEO may receive the MEC management interface information. The MEO may use the MEC management interface information to manage, configure, and/or orchestrate the Constrained MEC Host.

Systems, methods, and apparatuses are described herein with respect to Constrained MEC host initiated addition. A Constrained MEC Host may request MEO to join the MEC system by sending Security credential(s), Trust credential(s), and/or Host capability information. The host capability information may include available MEC management interfaces. The Constrained MEC host may receive a response from the MEO indicating if the request from the Constrained MEC Host is accepted or rejected along with integration option(s) supported by the MEO. The Constrained MEC Host may select the MEO suggested integration option(s) and/or may inform the MEO. The Constrained MEC Host may receive management, configuration, and/or orchestration information from the MEO on the selected management interfaces.

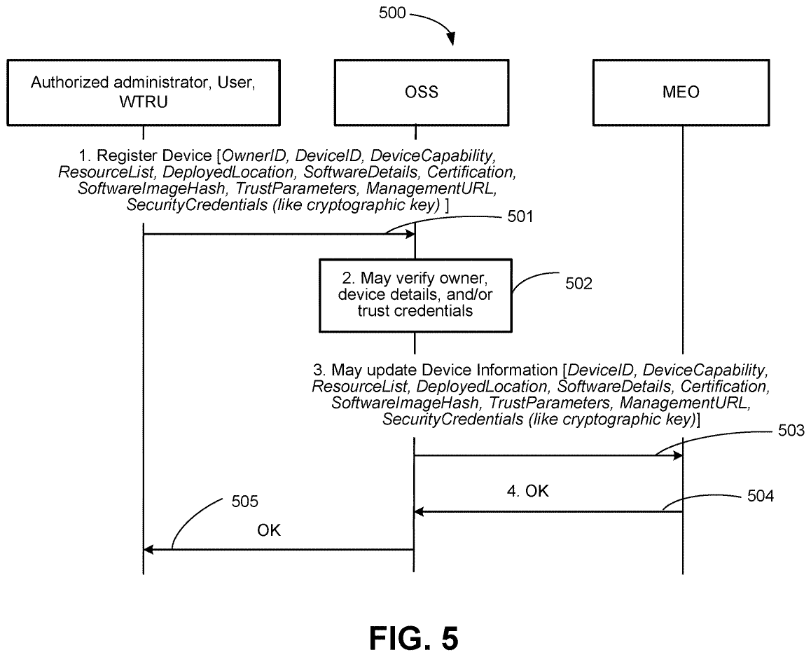

FIG. 5 illustrates a flow diagram depicting an example procedure 500 to configure an MEO 514 by an authorized user 510 (e.g., WTRU initiated). The procedure 500 may configure the MEC system with information related to the Constrained device and/or Constrained MEC Host. The MEO 514 may be the central entity which maintains information about one or more (e.g., all) MEC hosts in the MEC system, e.g., Telco edge and/or Constrained MEC hosts. The MEO 514 may not be accessed (e.g., directly) by an authorized user and/or device 510, for example, since the MEO 514 is the central entity that manages one or more (e.g., all) hosts. The MEO 514 may be accessed through OSS 512, which provides an interface and/or a portal to communicate with authorized users, devices 510, etc. Users and/or devices which can communicate with the MEC system, through OSS 512, may be authorized users, e.g. they have security credentials to interact with the MEC system.

At 501, an Authorized user 510, administrator, owner of a constrained device with constrained MEC host, and/or an authorized device, which wants to join the MEC system, may inform the MEO 514 (e.g., via the OSS 512) about the details of the constrained device and/or constrained MEC host. To update MEO 514, for example, the authorized user and/or the authorized device may (e.g., first) contact the OSS 512.

The OSS 512 may authenticate and/or authorize the request from the owner, administrator and/or a device. The OSS 512 may forward the Constrained MEC host/device information to the MEO 514. Additionally, or alternatively, the user request may indicate the service level being requested, charging information, etc.

The authorized user and/or the authorized device 510 may inform, at 501, the OSS 512 about the constrained host details. In examples, information may include the Identity of the owner of the device, so that OSS 512 can validate and/or authorize the request. In examples, the information may include a Device ID, which may be used by the MEO 514 to identify and/or authenticate a device. The device ID may be a secure ID, which cannot be tampered with and/or changed. The device ID also be a secure ID assigned by service provider, such as an IMEI number.

The authorized user and/or the authorized device 510 may inform, at 501, the OSS 512 about Device capability. In examples, the device capability information provided by the authorized user and/or device may indicate if the device 510 is a camera, robot, vehicle, drone for air surveillance, etc. If the device 510 is a camera, the OSS 512 may be informed of what capability the device 510 has for vision processing, etc. This information may be used by the MEO 514 to determine if the host can be added to support a specific service. For example, in the Industry 4.0 use case, a production line may be managed on the factory floor by deploying mobile cameras and/or robots. A mobile robot, which was not serving the production line earlier, may appear in close proximity. The MEO 514, with the knowledge that the constrained MEC host is a robot, may add the robot to monitor the production line.

The authorized user and/or the authorized device 510 may inform, at 501, the OSS 512 about a resource list, which provides details of the computing, storage, and/or power available in the constrained host. This information may be used by the MEC system to determine if the constrained MEC host can be added to support a service.

The authorized user and/or the authorized device 510 may inform, at 501, the OSS 512 about Deployed location. If the device 510 is deployed in a stationary location (e.g., non-mobile), for example, the device 510 may indicate the exact location where the device 510 is deployed. If the constrained MEC host is mobile, for example, location information may indicate a wider area where the constrained host is supposed to provide service (e.g., a civic address, geo-location information with a radius and/or other shape data defining an area, a mobility path that includes geo-location points with time of arrival, departure, speed, etc.). The deployed location information may include indoor location information (e.g., floor #, room #or area, and/or indoor coordinates, etc.). For mobile hosts, the location information may be used by the MEO 514 to receive a notification when the constrained MEC host becomes available in a specific location within the area. The MEO 514 may use the notification to initiate a procedure to add the constrained host.

The authorized user and/or the authorized device 510 may inform the OSS 512 about software details available in the host such as a list of software (e.g., including MEC applications, MEC services, etc.) and/or a version. It can also include a hash of the software image in the host. The MEO 514 can verify the software details and/or the software image hash to verify that the software in the host has not been tampered with. In examples, if the software has not been tampered with, the MEO 514 can add the host.

The authorized user and/or the authorized device 510 may inform the OSS about Trust parameters and/or certificates, security credentials, keys associated with the constrained host, and/or which MEC systems can verify with the host, for example, while adding the host to the MEC system. In examples, a system administrator may add a CMH, the system administrator may know the MEC system that may integrate the CMH, etc.

The authorized user and/or the authorized device 510 may inform the OSS 512 about a secured management URL. The MEO 514 may use the secured management URL to make one or more initial contacts with the constrained MEC host, for example, while adding the host to MEC system.

The authorized user and/or the authorized device 510 may inform the OSS 512 about MEC host integration option(s) supported by the constrained MEC host. In examples, the MEC host integration option(s) may support Mm5 and/or Mm7 if the CMH includes MEP and/or Virtualization infrastructure. In examples, the MEC host may support Mm3 and/or Mm4 if the CMH includes MEPM and/or Virtualization infrastructure manager.

At 502, the OSS 512 may verify the user, administrator, and/or the device creating the request. Additionally, or alternatively, the OSS 512 may verify and/or check the integrity of the information provided. The OSS 512 may verify the capability, resources, software and/or hardware details, certificates, and/or security credentials of the Constrained MEC host (e.g., determine whether the host meets the system requirement(s)). If the host does meet the system requirement(s), the OSS 512 may forward the request to the MEO 514. If the host does not meet the system requirement(s), the OSS 512 may reject the request.

At 503, the OSS 512 may forward the request from one or more authorized users, device owners, and/or from an authorized device to the MEO 514 with the information received, as described herein. The OSS 512 may indicate that the constrained MEC host information can be added to the MEC system. Additionally, or alternatively, the OSS 512 may indicate that the constrained MEC host, mobile or stationary device can be added by the MEO 514 dynamically, for example, when the MEO 514 determines the CMH is required to support a specific deployment and/or an application and/or service in a factory, location, building etc. Additionally, or alternatively, the OSS 512 may indicate that the MEO 514 should report back the usage of the constrained MEC host (e.g., when the CMH is added, what service(s) the CMH provides, etc.) for charging purpose. Additionally, or alternatively, the OSS 512 may indicate that the MEO 514 should provide its status, so that the OSS 512 can provide the status information to customer and/or authorized user in a customer portal.

The MEO 514 may update information about valid and/or authorized constrained devices with constrained MEC host, which can be added dynamically (e.g., at a later time). While updating its records, the MEO 514 may verify if the information received matches the MEC system requirement criteria. Additionally, or alternatively, the MEO 514 may verify if (e.g., any) previous and/or duplicate information about this device exists. If previous and/or duplicate information about the device exists, the MEO 514 may remove and/or update the record. At 504, if the MEO 514 is able to update the record properly, the MEO 514 may send an OK response to the OSS 512 to indicate that the database has been updated successfully. In examples, once the OSS 512 receives an indication that the database has been updated successfully at 505 the OSS 512 may update the device owner, authorized user, and/or the authorized device that the constrained device and/or the constrained MEC host information has been updated successfully.

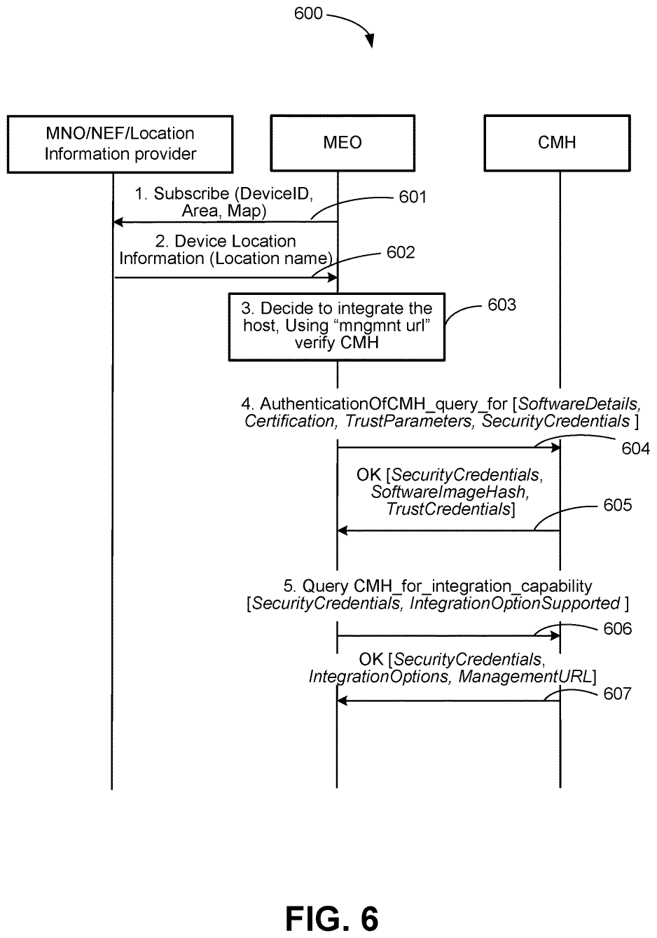

An MEO 612 may initiate the addition of a constrained MEC Host 614. FIG. 6 depicts an example procedure for MEO 612 initiated addition of a mobile CMH 614 at 600.

At 601, the MEO 612 may subscribe with an MNO 610 to be notified about a constrained MEC host 614 being available in a specific location. For example, the MEO 612 may subscribe with an MNO 610 through an NEF, via an Edge Enablement Layer like EDGEAPP, other Telco API, and/or Location service provider (e.g., via the MEC-012 Location service provider). The MEO 612 may provide the Device ID and/or the area and/or location of interest.

The Device ID may be the ID that the MEO 612 received from the user and/or verified by the OSS. The Device ID may be known to the MEO 612, MNO 610 and/or location service provider, and/or the authorized user. The area and/or location of interest may be the location where the MEO 612 prefers the constrained MEC host 614 to support an application and/or provide a desired service.

In examples, when the constrained MEC host 614 is available in the desired area, the MEO 612 may be notified by the MNO 610 Location service provider about the device available in that specific location at 602. The notification may indicate the Device ID, which may identify the constrained MEC host 614. Additionally, or alternatively, the notification may include a precise location of the constrained MEC host 614. The notification of the location may indicate indoor locations such as floor, block, segment, etc. The MEO 612 may determine how to integrate and add the constrained MEC host 614 to the MEC system, for example, based on the precise location of the constrained MEC host 614.

In examples, the MEO 612, after receiving the Device ID of a constrained MEC host 614 and/or the precise location where the constrained MEC host 614 is available, may look into its capability to support a service (e.g., if it is a camera and/or can support vision analysis). For example, in the production line monitoring application, a camera and/or robotic arm may be included. The camera may be mobile and/or go out of a service area. When a different CMH 614 (e.g., camera) becomes available in the area, the MEC may integrate it to continue service. The service may not be supported (e.g., if the CMH 614 is not a camera). Additionally, or alternatively, the MEO 612 may determine resource availability of the constrained MEC host 614, for example, if it has enough computational resources and/or storage to support the application. If the MEO 612 may determine that the constrained MEC host 614 can support the application and/or service in a specific location, at 603, the MEO 612 may determine to integrate (e.g., add) the host into the MEC system. Before the MEO 612 can integrate the constrained MEC host 614, for example, the MEO 612 may verify and/or authenticate the device. For verification and/or authentication, the MEO 612 may select the associated management URL (e.g., provided for the CMH 614 as described herein) of the constrained MEC host 614, which may be supplied by an authorized user while configuring MEO 612 with device information.

At 604, the MEO 612 may use the management URL provided by the user to contact the constrained MEC host 614 to validate and/or authenticate the MEC host.

The MEO 612 may request the constrained MEC host 614 to send security credentials to validate and/or authenticate the host. Additionally, or alternatively, the MEO 612 may request certificates and trust parameters to verify that the host has not been tampered with. The MEO 612 may request for software image hash to verify that the software entities available in the host are the same as described by the user and/or that the (e.g., software) entities have not been compromised. At 605, the constrained MEC host 614 may provide the requested information to the MEO 612. The MEO 612 may verify the information received from constrained MEC host 614 against the information provided by authorized user and/or the OSS. If the MEO 612 is satisfied with the information and/or determines that the constrained MEC host 614 is valid and not compromised, the MEO 612 may proceed further with integration procedure. Otherwise, the MEO 612 may abandon the process.

The MEO 612 may determine the integration option(s) supported by CMH 614 from the information provided, as described herein. If the information is not available, the MEO 612 may use the management URL provided by the user to contact the constrained MEC host 614 to request information indicating which integration option(s) the device supports at 606. The integration option(s) supported by the constrained MEC host 614 may indicate what one or more (e.g., all) MEC interfaces it supports. For example, if the constrained MEC host 614 includes MEP and Virtualization infrastructure, the constrained MEC host 614 may support Mm5 and/or Mm7. If the Constrained MEC Host 614 includes MEPM and/or Virtualization infrastructure manager, the Constrained MEC Host 614 may support Mm3 and/or Mm4.

At 607, the Constrained MEC Host 614 may respond indicating the integration option it supports and/or including the interfaces it supports. These interfaces may include one or more ETSI MEC management interfaces, and/or may be accessible by the MEO 612. The MEO 612 may use one or more ETSI MEC management interfaces to manage and/or orchestrate the constrained MEC host 614.

A Constrained MEC host 614 may initiate the addition of a MEC Host. The CMH 614 may start the procedure (e.g., under certain condition(s)). One or more procedures may include initial authentication and/or verification of CMH 614 by MEO 612 based on configuration information received, as described herein.

The Constrained MEC host 614 may become available in a specific location and/or be capable of providing a specific service and/or application support. The constrained MEC host 614 may contact the MEO 612 to request that it is added to the MEC system. The knowledge about service requirements in a location can be configured in the constrained MEC host 614. The constrained MEC host 614 can become aware of its location from location services. When the constrained MEC host 614 becomes aware that its location warrants addition to the MEC system (e.g., device enters a specific location) and/or can support the service requirement, the constrained MEC host 614 may initiate contacting the MEO 612 to become part of the system. The constrained MEC host 614 may be provisioned with information about how to contact MEO 612 (e.g., a management URL for dynamic MEC host addition requests).

Additionally, or alternatively, an application level mechanism can be used to initiate the procedure. For example, an application function (AF) (e.g., outside the network or in the 5GC) may become aware of the location and/or availability of a constrained MEC host 614. The AF may be aware of the service deployment and/or service requirement in a given location. The AF may determine that the constrained MEC host 614 can provide the desired service to support the application and/or use case (e.g. Smart factory, autonomous vehicle). At the application level interaction, for example, the AF may trigger a constrained MEC host to initiate the procedure. Additionally, or alternatively, the AF may be configured (e.g., at that time) with information about how to reach the MEO 612. Additionally, or alternatively, an authorized user, through a customer portal and/or application function, may trigger the CMH 614 to initiate the procedure.

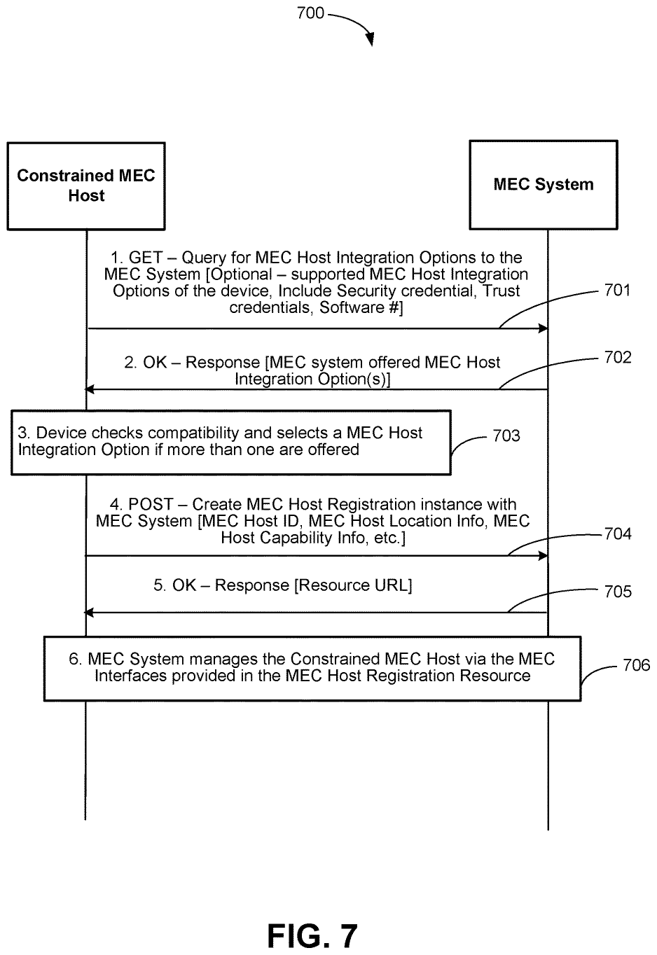

FIG. 7 depicts an example procedure for CMH 710 initiated addition and/or joining MEC system 720 at 700.

At 701, the constrained MEC host 710 (e.g., a WTRU) may initiate the procedure by sending a request to the MEO about the options constrained for MEC host integration. For example, the request may be associated with MEC host integration. The request may indicate the intention of the constrained MEC host 710 to join the MEC system 720. The request may be verified and/or authenticated by MEO and/or MEC system(s) 720.

The constrained MEC host 710 may send security credentials, such as software details, hashes of software image, trust parameters, and/or certificates to the MEO with (e.g., comprised in) the request. This set of information may match what the authorized user and/or administrator provided to the MEC system 720 in the MEO configuration procedure. The MEO may validate the request based on, for example, what was configured in the MEO configuration procedure. The MEO may validate the request based on, for example, the security credentials and/or may enable the constrained MEC host 710 to become part of the MEC system 720.

The request may indicate to the MEO that the constrained MEC host 710 intends to join the MEC and/or is requesting for MEC Host integration options supported by the MEO. For example, the constrained MEC host 710 may request for MEC host integration procedures if the device supports integration over Mm5 and/or Mm7 (e.g., if the constrained MEC host 710 includes MEP (Mobile Edge Platform) and/or Virtualization infrastructure). For example, the constrained MEC host 710 may request for MEC host integration procedures if the device supports integration over Mm3 and/or Mm4 (e.g., if the constrained MEC host 710 includes Mobile Edge Platform Manager (MEPM) and/or Virtualization infrastructure manager). Additionally, or alternatively, the request may indicate to the MEO what are the MEC host integration options the constrained MEC host 710 supports.

The MEO may validate the request from the constrained MEC host 710. The MEO may verify the security credential, hash of software image, trust parameters, and/or certificates. If the constrained MEC host 710 is validated by MEO against the information received at configuration, for example, the MEO may proceed further with the integration.

At 702, the MEO may respond to the constrained MEC host 710 that its request has been accepted. The MEO may provide, in the response to the constrained MEC host 710, an indication of one or more MEC host integration options that the MEC system 720 (e.g., the MEO) supports. For example, the constrained MEC host 710 may receive the response from the MEO. The constrained MEC host 710 may determine whether any of the host integration options are mandatory. For example, the MEO may indicate whether the one or more MEC host integration options are mandatory.

The constrained MEC host 710 may consider the MEC host integration procedures provided by MEO. At 703, the constrained MEC host 710 may select one or more of the MEC host integration options based on one or more capabilities of the constrained MEC host 710 (e.g., whether the constrained MEC host 710 supports one or more of the selected host integration options) and/or the procedures offered by MEO. If it is indicated mandatory by MEO, for example, the constrained MEC host 710 may select the option specified by MEO (e.g., if the constrained MEC host 710 can). Otherwise, the constrained MEC host 710 may indicate to MEO that it may not support the mandatory option(s).

At 704, the constrained MEC host 710 may inform the MEC system 720 about the selected host integration option(s) (e.g., by sending a notification to the MEO). For example, the constrained MEC host 710 may send a notification to the MEC system 720 that indicates the one or more selected host integration options. If the MEO indicated a mandatory option, for example, the constrained MEC host 710 may indicate it can support the specified option and/or may inform its inability to support the integration option.

The MEO may receive the selected and/or accepted integration option(s) from the constrained MEC host 710. The MEO may select the corresponding resource URL for the selected integration option(s). At 705, the MEO may send the corresponding resource address and/or URL to the constrained MEC host 710. At 706, the MEC system 720 may manage the constrained MEC host 710 using the resource URL that was sent as described herein.

What is claimed is:

1. A method implemented by a wireless transmit/receive unit (WTRU), the method comprising:
sending a request associated with multi-access edge computing (MEC) host integration, wherein the request comprises security credentials and an indication that the WTRU intends to join a MEC system;
receiving a response that indicates host integration options supported by the MEC system;
selecting one or more host integration options indicated in the response based on one or more capabilities associated with the WTRU; and
sending a notification to the MEC system that indicates the one or more selected host integration options.

2. The method of claim 1, wherein the one or more capabilities associated with the WTRU comprise the WTRU supporting the one or more selected host integration options.

3. The method of claim 1, further comprising determining whether any of the host integration options are indicated as mandatory.

4. The method of claim 1, wherein the host integration options comprise one or more of support of integration over Mm3 and Mm4, support of integration over Mm5 and Mm7, MEP and virtualization infrastructure, or MEPM and virtualization infrastructure manager.

5. The method of claim 1, wherein the WTRU is a constrained MEC host.

6. The method of claim 1, wherein the security credentials comprise one or more of software details, a hash of a software image, trust parameters, or certificates to be used by a MEC orchestrator (MEO) to validate the request.

7. The method of claim 1, wherein the request indicates one or more host integration options supported by the WTRU.

8. The method of claim 1, wherein the request is sent to a MEC orchestrator (MEO) of the MEC system.

9. The method of claim 1, further comprising receiving a resource address that corresponds to the selected host integration options supported by the MEC system.

10. The method of claim 1, wherein the request is sent to an Operations Support System (OSS) associated with the MEC system.

11. A wireless transmit/receive unit (WTRU) comprising a processor and memory, the processor and memory configured to:
send a request associated with multi-access edge computing (MEC) host integration, wherein the request comprises security credentials and an indication that the WTRU intends to join a MEC system;
receive a response that indicates host integration options supported by the MEC system;
select one or more host integration options indicated in the response based on one or more capabilities associated with the WTRU; and
send a notification to the MEC system that indicates the one or more selected host integration options.

12. The WTRU of claim 11, wherein the one or more capabilities associated with the WTRU comprise the WTRU supporting the one or more selected host integration options.

13. The WTRU of claim 11, wherein the processor and memory are further configured to determine whether any of the host integration options are indicated as mandatory.

14. The WTRU of claim 11, wherein the host integration options comprise one or more of support of integration over Mm3 and Mm4, support of integration over Mm5 and Mm7, MEP and virtualization infrastructure, or multi access edge platform manager (MEPM) and virtualization infrastructure manager.

15. The WTRU of claim 11, wherein the WTRU is a constrained MEC host.

16. The WTRU of claim 11, wherein the security credentials comprise one or more of software details, a hash of a software image, trust parameters, or certificates to be used by a MEC orchestrator (MEO) to validate the request.

17. The WTRU of claim 11, wherein the request indicates one or more host integration options supported by the WTRU.

18. The WTRU of claim 11, wherein the request is sent to a MEC orchestrator (MEO) of the MEC system.

19. The WTRU of claim 11, wherein the processor and memory are further configured to receive a resource address that corresponds to the selected host integration options supported by the MEC system.

20. The WTRU of claim 11, wherein the request is sent to an Operations Support System (OSS) associated with the MEC system.
